(19) United States
(12) Patent Application Publication
(10) Pub. No.: US 2026/0163023 A1
(43) Pub. Date: Jun. 11, 2026

(54) BIPOLAR PLATE FOR A FUEL CELL UNIT

(71) Applicant: Robert Bosch GmbH, Stuttgart (DE)

(72) Inventor: Eberhard Maier, Koengen (DE)

(21) Appl. No.: 18/706,506

(22) PCT Filed: Oct. 24, 2022
(86) PCT No.: PCT/EP2022/079515

§ 371 Date: May 1, 2024

(30) Foreign Application Priority Data
Nov. 23, 2021 (DE) 10 2021 213 135.2

(51) Int. Cl. H01M 8/0267; H01M 8/0254; H01M 8/0258; H01M 8/04082; H01M 8/10; H01M 8/241

(52) U.S. Cl. CPC H01M 8/0267; H01M 8/0254; H01M 8/0258; H01M 8/04201; H01M 8/241; H01M 2008/1095

(57) ABSTRACT

A bipolar plate (10) for a fuel cell unit comprising: a first plate (59), a second plate (60), wherein the first plate (59) and second plate are stacked on top of each other, a fluid opening (57) for supplying coolant to channels (14) of the bipolar plate (10) for coolant in an active region (80), a fluid opening (58) for discharging coolant from channels (14) of the bipolar plate (10) for coolant in the active region (80), channel structures (29) with the channels for fuel, oxidants and coolants in the active region (80), wherein the channels for coolant are formed in the active region (80) between the first and second plate (59), an outer bead (63) which is formed on an outer edge region (62) of the bipolar plate (10) and encloses the fluid opening (57) for supplying coolant and the fluid opening (58) for discharging coolant, a coolant supply bead (65) which encloses the fluid opening (57) for supplying coolant to channels of the bipolar plate (10) for coolant, a coolant discharge bead (66) which encloses the fluid opening (58) for discharging coolant from channels of the bipolar plate (10) for coolant, wherein a first fluid-conducting connection (71) from the coolant supply bead (65) into the outer bead (63) and a second fluid-conducting connection (72) from the outer bead (63) into the coolant discharge bead (66) are designed to remove conditioning fluid from the outer bead (63).

### BACKGROUND

The present invention relates to a bipolar plate, a method for conditioning a bipolar plate, a fuel cell unit, and a fuel cell system.

Fuel cell units acting as galvanic cells convert continuously supplied fuel and an oxidizer into electrical energy by means of redox reactions at an anode and a cathode. Fuel cells are used in a wide variety of stationary and mobile applications, e.g., in homes without connection to a power grid or in motor vehicles, rail transport, aviation, space travel, and marine applications. A large number of fuel cells are stacked in the fuel cell unit to form a fuel cell stack. Channels for conducting fuel, channels for conducting oxidizers, and channels for conducting coolant are integrated into the fuel cell stack.

The fuel cells comprise, among other things, a proton exchange membrane, an anode, and a cathode, each having a catalyst layer, a gas diffusion layer, and a bipolar plate. The proton exchange membrane comprising the anode and cathode forms a membrane electrode arrangement. A gas chamber for fuel is formed between the anode and the bipolar plate and a gas diffusion layer is also arranged in this gas chamber. Similarly, a gas chamber for oxidizers is formed between the cathode and the bipolar plate, and the gas diffusion layer is also arranged in this gas chamber. The bipolar plate is electrically conductive, but impermeable to gases and ions and distributes the oxidizer and the fuel due to a corresponding structure (elevations), e.g. bars, nozzles, walls or a deep-drawn structure comprising channels, a channel structure, or a flow field. The gas diffusion layer also has the task of enabling the fuel and the oxidizer to be distributed as evenly as possible from the channel structure or the flow field on the bipolar plate to the anode and cathode comprising the catalyst with catalyst particles.

Bipolar plates, for example made of metal, generally consist of a first plate and a second plate. Between the first and second plate, a flow space is formed for coolant as a cooling fluid, in particular cooling fluid. An outer circumferential weld seam and an outer circumferential bead are formed on an outer edge region of the bipolar plate. After mechanical production of the fuel cell unit with the stacked fuel cells, conditioning of the fuel cell unit is necessary before the fuel cell unit is put into operation, for example to moisten the membrane. For this purpose, a conditioning fluid is conducted through the channels of the fuel cell unit. This conditioning fluid is without antifreeze and after conditioning, the conditioning fluid without antifreeze remains in the outer circumferential bead between the outer edge as wide sides of the bipolar plate and fluid openings of the bipolar plate. This conditioning fluid also remains in this region of the outer circumferential bead during and after the conduction of a flushing fluid or coolant through the channels of the fuel cell unit for coolant. As a result, frost damage can occur to the fuel cell unit at temperatures below 0° due to the conditioning fluid in this partial region of the outer circumferential bead without antifreeze.

EP 3 350 864 B1 discloses a separator plate for an electrochemical system, comprising at least one through opening for forming a media channel for supplying media or for discharging media; at least one bead arrangement arranged around the at least one through-opening for sealing the through-opening, whereby at least one of the flanks of the bead arrangement has at least one opening for conducting a medium through the bead flank, and at least one conduit channel, which adjoins the aperture in the bead flank on an outer side of the bead arrangement and which is in fluidic connection to a bead interior via the aperture in the bead flank, whereby the conduit channel is designed such that a width of the conduit channel determined parallel to the plane of the separator plate increases at least in sections towards the bead arrangement.

DE 102 48 531 B4 discloses a fuel cell system consisting of a fuel cell stack comprising a layering of a plurality of fuel cells which are separated from each other by bipolar plates, whereby the bipolar plates have openings for cooling or media supply and removal to the fuel cells and the fuel cell stack can be placed under mechanical compressive stress in the direction of the layering, whereby elastic bead arrangements are provided around the openings of the bipolar plate, whereby openings for the conduction of fluid or gaseous media are arranged on at least one flank of the bead arrangements.

DE 10 2017 124 498 A1 discloses a bipolar plate having at least one bead, the bead comprising a plurality of edge portions and a plurality of trough portions having at least one tangent portion arranged between adjacent edge portions and trough portions, and the bipolar plate further comprising at least one tunnel defining at least one through hole within the at least one tangent portion.

### SUMMARY

A bipolar plate for a fuel cell unit according to the invention comprising: a first plate, a second plate, wherein the first plate and second plate are stacked on top of each other, a fluid port for supplying coolant to channels of the bipolar plate for coolant at an active region, a fluid port for discharging coolant from channels of the bipolar plate for coolant at the active region, channel structures comprising channels for fuel, oxidizer and coolant at the active region, whereby the channels for coolant at the active region are formed between the first and second plate, preferably an outer bead, which is preferably formed at an outer edge region of the bipolar plate and preferably encloses the fluid opening for supplying coolant and the fluid opening for discharging coolant, a coolant supply bead which encloses the fluid opening for supplying coolant to channels of the bipolar plate for coolant, a coolant discharge bead which encloses the fluid opening for discharging coolant from channels of the bipolar plate for coolant, whereby a first fluid-conducting connection is formed from the coolant supply bead into the outer bead and a second fluid-conducting connection being formed from the outer bead into the coolant discharge bead for removing conditioning fluid from the outer bead. The first fluid-conducting connection and the second fluid-conducting connection enable, in particular at a pressure less than 1.2 bar or 2 bar and/or without an overpressure greater than 1 bar or 2 bar, between the first and second plate, a controlled flow through the outer circumferential bead at a region of the outer circumferential bead between the outer edge and the fluid openings of the bipolar plate. Therefore, after conditioning the fuel cell unit using the conditioning fluid without antifreeze, the conditioning fluid can be essentially completely flushed or blown out of the outer circumferential bead using the flushing fluid.

In an additional embodiment, a coolant supply weld seam is formed between the first and second plates and encloses the fluid opening for supplying coolant to channels of the bipolar plate for coolant.

In a further variant, a coolant discharge weld seam is formed between the first and second plate and encloses the fluid opening for discharging coolant from channels of the bipolar plate for coolant.

In a further embodiment, the coolant supply weld seam encloses the coolant supply bead so that the distance of the coolant supply weld seam in a direction parallel to an imaginary plane spanned by the bipolar plate to the fluid opening for supplying coolant to channels of the bipolar plate for coolant is greater than the distance of the coolant supply bead in this direction to the fluid opening for supplying coolant to channels of the bipolar plate for coolant.

In another embodiment, the coolant discharge weld seam encloses the coolant discharge bead, so that the distance of the coolant discharge weld seam in a direction parallel to an imaginary plane spanned by the bipolar plate to the fluid opening for discharging coolant from channels of the bipolar plate for coolant is greater than the distance of the coolant discharge bead in this direction to the fluid opening for discharging coolant from channels of the bipolar plate for coolant.

Preferably, the first fluid-conducting connection from the coolant supply bead to the outer bead is designed as an interruption in the coolant supply weld seam.

In an additional variant, the second fluid-conducting connection from the coolant discharge bead to the outer bead is designed as an interruption in the coolant discharge weld seam.

In a further embodiment, the first fluid-conducting connection from the coolant supply bead into the outer bead and/or the second fluid-conducting connection from the outer bead into the coolant discharge bead is designed as a connecting bead and/or as a connecting channel between the first and second plate.

An outer bead, which is formed on the outer edge region of the bipolar plate, is formed completely around the outer edge region.

In the method according to the invention for conditioning a fuel cell unit comprising stacked fuel cells before starting the fuel cell unit and in bipolar plates of the fuel cells of the fuel cell unit channels for conducting a fuel, channels for conducting an oxidizer and channels for conducting a coolant are formed using the following steps: providing a conditioning fluid, conducting the conditioning fluid through the channels for fuel and/or conducting the conditioning fluid through the channels for oxidizers and/or conducting the conditioning fluid through the channels for coolant, whereby the method is performed using a fuel cell unit described in the present patent application comprising fuel cells with bipolar plates and/or, after conducting the conditioning fluid through the fuel channels and/or after conducting the conditioning fluid through the oxidizer channels and/or after conducting the conditioning fluid through the coolant channels, the conditioning fluid is essentially completely discharged from the outer beads of the bipolar plates. Essentially complete discharge from the outer beads of the bipolar plates preferably means that at least 90%, 95%, 98% or 99% of the conditioning fluid is discharged from the outer beads.

In an additional embodiment, after the conditioning fluid has been guided through, a flushing fluid is guided through the fluid openings for supplying coolant and the fluid openings for discharging coolant, so that the conditioning fluid is essentially completely discharged from the flushing fluid in the outer beads, in particular being replaced by conducting the flushing fluid through the first fluid-conducting connections from the coolant supply beads into the outer beads and through the second fluid-conducting connections from the outer beads into the coolant discharge beads, and preferably the pressure of the flushing fluid is less than 5 bar, 2 bar or 1.2 bar.

Preferably, the flushing fluid is a flushing gas or a flushing fluid.

In a further variant, after conducting the conditioning fluid through the channels for fuel and/or after conducting the conditioning fluid through the channels for oxidizer and/or after conducting the conditioning fluid through the channels for coolant, the conditioning fluid is discharged from the outer beads of the bipolar plates by increasing the pressure of fluids in the channels for fuel and/or oxidizer and/or coolant, in particular greater than 1 bar, 5 bar, 10 bar or 20 bar, so that the expansion of the fuel cell stack perpendicular to the imaginary planes is increased due to expansions and a gap is formed between the first and second plates on each bipolar plate and the fluid, in particular as a flushing fluid, is introduced into the outer beads through each gap.

In the fuel cell unit according to the invention for the electrochemical generation of electrical energy, comprising stacked fuel cells and the fuel cells each comprise stacked layered components and the components of the fuel cells are proton exchange membranes, anodes, cathodes, gas diffusion layers, and bipolar plates, and the stacked fuel cells form a fuel cell stack, whereby the bipolar plates are designed as bipolar plates described in the present patent application.

A fuel cell system according to the invention, in particular for a motor vehicle, comprising a fuel cell unit as a fuel cell stack having fuel cells, at least one compressed gas storage means for storing gaseous fuel, a gas conveying device for conveying a gaseous oxidizer to the cathodes of the fuel cells, whereby the fuel cell unit is designed as a fuel cell unit described in the present patent application.

In an additional variant, the first and second plates are each stacked in a flush manner on a bipolar plate.

Preferably, the bipolar plate is at least partially, in particular completely, made of metal, in particular steel, preferably stainless steel, and/or conductive plastic and/or composite material and/or graphite.

In a further variant, the first fluid-conducting connection and/or the second fluid-conducting connection is formed, in particular exclusively, between an outer edge as the broad side of the bipolar plate and fluid openings of the bipolar plate.

In an additional variant, the first plate and second plate are connected together in a bonded manner, in particular by means of a weld seam.

In particular, the coolant supply weld seam is formed between the outer bead and the fluid opening for supplying coolant.

Preferably, the coolant discharge weld seam is formed between the outer bead and the fluid opening for discharging coolant.

In a further variant, the bipolar plate comprises a fluid port for supplying fuel to channels of the bipolar plate for fuel at an active region.

Preferably, the bipolar plate comprises a fluid port for supplying oxidizer to channels of the bipolar plate for oxidizer at the active region.

In a complementary embodiment, the bipolar plate comprises a fluid port for discharging fuel from channels of the bipolar plate for fuel at the active region.

Conveniently, the bipolar plate comprises a fluid port for discharging oxidant from channels of the bipolar plate for oxidant at the active region.

In a further embodiment, the outer bead, which is formed on an outer edge region of the bipolar plate, encloses all 3 fluid openings for supplying fuel, oxidizer and coolant and all 3 fluid openings for discharging fuel, oxidizer and coolant.

In a further variant, the coolant supply bead encloses, in particular completely, the fluid opening for supplying coolant.

In a supplementary embodiment, the coolant discharge bead encloses, in particular completely, the fluid opening for discharging coolant.

In a complementary embodiment, the bipolar plate comprises an oxidant supply bead, an oxidant removal bead, a fuel supply bead and a fuel removal bead.

The oxidizer supply bead conveniently encloses, in particular completely, the fluid opening for supplying oxidizer.

In particular, the oxidizer removal bead encloses, especially completely, the fluid opening for removing oxidizer.

In a supplementary embodiment, the fuel supply bead encloses, in particular completely, the fluid opening for supplying fuel.

In a further variant, the fuel discharge bead encloses, in particular completely, the fluid opening for discharging fuel.

In a further variant, the fuel cell unit comprises at least one connection device, in particular multiple connection devices, and tensioning elements.

In a further embodiment, the fuel cells each comprise a proton exchange membrane, an anode, a cathode, at least one gas diffusion layer, and at least one bipolar plate.

In a further embodiment, the connecting device is designed as a bolt and/or is rod-shaped.

The tensioning elements are advantageously designed as clamping plates.

In a further variant, the gas conveying device is designed as a blower or a compressor.

In particular, the fuel cell unit comprises at least 3, 4, 5 or 6 connection devices.

In an additional embodiment, the tensioning elements are plate-shaped and/or disc-shaped and/or planar and/or designed as a grid.

Preferably, the fuel is hydrogen, hydrogen-rich gas, reformate gas, or natural gas.

Advantageously, the fuel cells and/or components are designed to be substantially flat and/or disk-shaped.

In an additional embodiment, the oxidizer is air, comprising oxygen or pure oxygen.

Preferably, the fuel cell unit is a PEM fuel cell unit comprising PEM fuel cells (polymer electrolyte membrane fuel cell).

### BRIEF DESCRIPTION OF THE DRAWINGS

In the following, exemplary embodiments of the invention are described in more detail with reference to the accompanying drawings. Shown are:

FIG. 1 a highly simplified exploded view of a fuel cell system with components of a fuel cell,

FIG. 2 a perspective view of a portion of a fuel cell,

FIG. 3 a longitudinal section through a fuel cell,

FIG. 4 a perspective view of a fuel cell stack without a housing,

FIG. 5 a section through a fuel cell unit with a housing,

FIG. 6 a highly simplified perspective view of a bipolar plate,

FIG. 7 a detailed top view of the bipolar plate,

FIG. 8 a section A-A according to FIG. 7 of the bipolar plate,

FIG. 9 a section B-B according to FIG. 7 of the bipolar plate,

FIG. 10 a section C-C according to FIG. 7 of the bipolar plate,

FIG. 11 a section D-D according to FIG. 7 of the bipolar plate and

FIG. 12 a section C-C according to FIG. 7 of the bipolar plate in a second exemplary embodiment.

### DETAILED DESCRIPTION

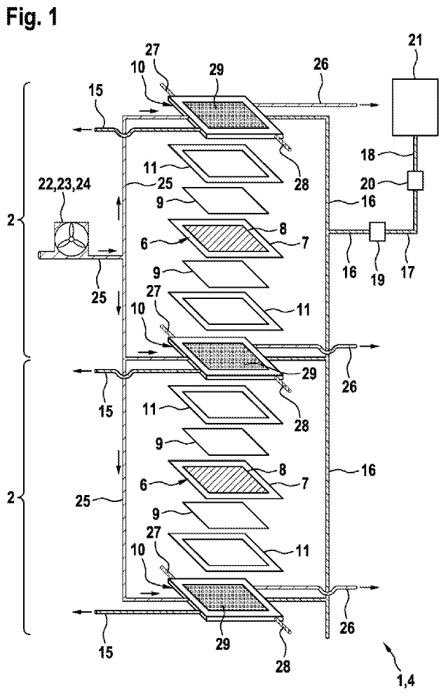

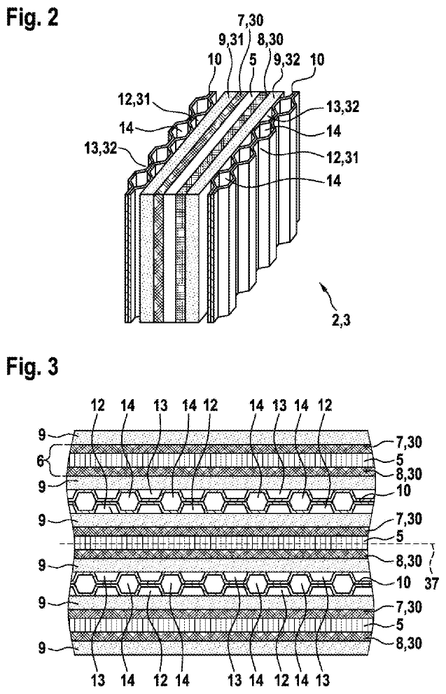

In FIGS. 1 to 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air provides the necessary gaseous oxidant. A reduction (electron uptake) takes place on the cathode 8. The oxidation as electron output is performed at the anode 7.

The redox equations of the electrochemical processes are as follows:

### Cathode:

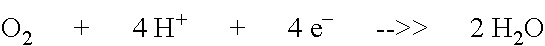

### Anode:

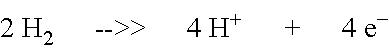

### Summed Reaction Equation of Cathode and Anode:

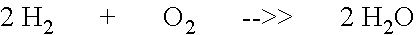

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation at larger currents, voltages between 0.5 V and 1.0 V are achieved. The series connection of a plurality of fuel cells 2, in particular a fuel cell unit 1 with a fuel cell stack 40 of a plurality of fuel cells 2 arranged one above the other, has a higher voltage, which corresponds to the number of fuel cells 2 multiplied by the individual voltage of each fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen H₂, i.e., it blocks the flow of oxygen O₂ and hydrogen H₂ between a gas chamber 31 at the anode 7 with fuel hydrogen H₂ and the gas chamber 32 at the cathode 8 with air or oxygen O₂ as oxidizers. The proton conductivity of the PEM 5 increases with increasing temperature and increasing water content.

On the two sides of the PEM 5, each facing the gas chambers 31, 32, the electrodes 7, 8 are located as the anode 7 and cathode 8. A unit consisting of the PEM 5 and anode 7, as well as a cathode 8, is referred to as a “membrane electrode assembly” 6 (MEA). The electrodes 7, 8 are pressed together using the PEM 5. The electrodes 7, 8 are platinum-containing carbon particles bonded to PTFE (polytetrafluorethylene), FEP (fluorinated ethylene-propylene copolymer), PFA (perfluoroalkoxy), PVDF (polyvinylidene fluoride), and/or PVA (polyvinyl alcohol) and hot-pressed in microporous carbon fiber, glass fiber, or plastic mats. A catalyst layer 30 is normally applied to each of the electrodes 7, 8 on the side facing the gas chambers 31, 32 (not shown). The catalyst layer 30 at the gas chamber 31 with fuel at the anode 7 comprises nanodispersed platinum-ruthenium on graphitized carbon black particles bonded to a binder. The catalyst layer 30 on the gas chamber 32 having oxidizer on the cathode 8 similarly comprises nanodispersed platinum. For example, binders include Nafion®, a PTFE emulsion, or polyvinyl alcohol.

Deviating from this, the electrodes 7, 8 are composed of an ionomer, for example Nafion®, platinum-containing carbon particles and additives. These electrodes 7, 8 comprising the ionomer are electrically conductive due to the carbon particles and also conduct the protons H⁺ and also act as a catalyst layer 30 due to the platinum-containing carbon particles. Membrane electrode arrangements 6 having these electrodes 7, 8 and comprising the ionomer form membrane electrode arrangements 6 as CCM (catalyst coated membrane).

A gas diffusion layer 9 (GDL) is located on the anode 7 and cathode 8. The gas diffusion layer 9 at the anode 7 evenly distributes the fuel from channels 12 for fuel to the catalyst layer 30 at the anode 7. The gas diffusion layer 9 on the cathode 8 evenly distributes the oxidizer from channels 13 for oxidizer onto the catalyst layer 30 at the cathode 8. The GDL 9 also draws reaction water counter to the direction of flow of the reaction gases, i.e. in a direction from the catalyst layer 30 to the channels 12, 13. Furthermore, the GDL 9 keeps the PEM 5 moist and conducts the power. For example, the GDL 9 is constructed from a hydrophobized carbon paper and a bonded layer of carbon powder.

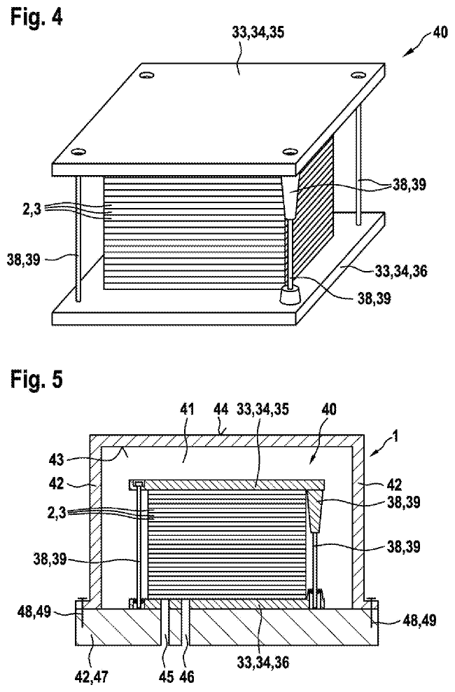

A bipolar plate 10 lies atop the GDL 9. The electrically conductive bipolar plate 10 serves as a current collector, for diverting water, for conducting the reaction gases through a channel structure 29 and/or a flow field 29, and for dissipating the waste heat, which occurs in particular in the exothermic electrochemical reaction on the cathode 8. To dissipate the waste heat, channels 14 for conducting a fluid or gaseous coolant are formed in the bipolar plate 10. The channel structure 29 on the gas chamber 31 for fuel is formed by channels 12. The channel structure 29 on the gas chamber 32 for oxidizers is formed by channels 13. The materials used for the bipolar plates 10 include metal, conductive plastics, and composites or graphite. The bipolar plate 10 thus comprises the three channel structures 29 formed by the channels 12, 13, and 14 for separately conducting fuel, oxidizer, and coolant. In a fuel cell unit 1 comprising a fuel cell stack 40 and/or a fuel cell stack 40, a plurality of fuel cells 2 are arranged in a flush stack (FIG. 4). The fuel cells 2 and the components 5, 6, 7, 8, 9, 10 of the fuel cells 2 are layered and/or disk-shaped and span imaginary planes 37 (FIG. 3). The components 5, 6, 7, 8, 9, 10 of the fuel cells 2 are proton exchange membranes 5, anodes 7, cathodes 8, gas diffusion layers 9, and bipolar plates 10.

An exploded view of two stacked fuel cells 2 is depicted in FIG. 1. A seal 11 seals the gas chambers 31, 32 in a fluidically sealed manner. In a compressed gas storage means 21 (FIG. 1), hydrogen H₂ is stored as a fuel at a pressure of, e.g., 350 bar to 800 bar. From the compressed gas storage means 21, the fuel is conducted through a high pressure conduit 18 to a pressure reducer 20 in order to reduce the pressure of the fuel in a medium pressure conduit 17 of about 10 bar to 20 bar. From the medium pressure conduit 17, the fuel is conducted towards an injector 19. At the injector 19, the pressure of the fuel is reduced to an injection pressure of between 1 bar and 3 bar. From the injector 19, the fuel is supplied to a fuel supply conduit 16 (FIG. 1) and from the supply conduit 16 to the fuel channels 12 forming the channel structure 29 for fuel. As a result, the fuel flows through the gas chamber 31 for the fuel. The gas chamber 31 for the fuel is formed by the channels 12 and the GDL 9 at the anode 7. After flowing through the channels 12, the fuel not consumed in the redox reaction at the anode 7 (and optionally water) are discharged from a controlled humidification means of the anode 7 via a discharge conduit 15 from the fuel cells 2.

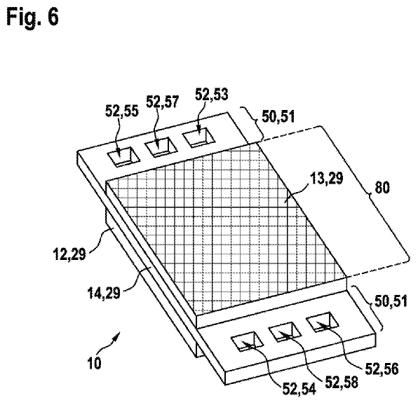

A gas conveying device 22 designed as, e.g., a blower 23 or a compressor 24, conveys air from the surroundings as an oxidizer into an oxidizer supply conduit 25. From the supply conduit 25, the air is supplied to the oxidizer channels 13, which form a channel structure 29 on the bipolar plates 10 for oxidizers such that the oxidizer flows through the gas chamber 32 for the oxidizer. The gas chamber 32 for the oxidizer is formed by the channels 13 and the GDL 9 on the cathode 8. After flowing through the channels 13 or the gas chamber 32 for the oxidizer 32, the oxidizer not consumed on the cathode 8 and the reaction water resulting on the cathode 8 due to the electrochemical redox reaction are discharged from the fuel cells 2 through a discharge conduit 26. A supply conduit 27 is used to supply coolant into the channels 14 for coolant, and a discharge conduit 28 is used to discharge coolant conducted through the channels 14. The supply and discharge conduits 15, 16, 25, 26, 27, 28 are shown in FIG. 1 as separate conduits for reasons of simplification and are actually designed at the end region near the channels 12, 13, 14 in the fuel cell stack 40 of the fuel cell unit 1 as flush fluid openings 52 on sealing plates 50 as an extension at the end region 51 of the bipolar plates 10 (FIG. 6) and membrane electrode arrangements 6 (not shown) lying one on top of the other. The fuel cells 2 and the components of the fuel cells 2 are disk-shaped and span imaginary planes 37 that are essentially parallel to one another. The fluid openings 52 and seals (not shown), which are flush in a direction perpendicular to the imaginary planes 37 between the fluid openings 52 thus form a supply channel 53 for oxidizer, a discharge channel 54 for oxidizer, a supply channel 55 for fuel, a discharge channel 56 for fuel, a supply channel 57 for coolant, and a discharge channel 58 for coolant. The supply and discharge conduits 15, 16, 25, 26, 27, 28 outside the fuel cell stack 40 of the fuel cell unit 1 are designed as process fluid conduits. The feed and discharge conduits 15, 16, 25, 26, 27, 28 outside the fuel cell stack 40 of the fuel cell unit 1 open into the feed and discharge channels 53, 54, 55, 56, 57, 58 inside the fuel cell stack 40 of the fuel cell unit 1. The fuel cell stack 40 as fuel cell unit 1 together with the compressed gas storage means 21 and the gas conveying device 22 form a fuel cell system 4.

In the fuel cell unit 1, the fuel cells 2 are arranged between two clamping elements 33 as clamping plates 34. An upper clamping plate 35 lies atop the uppermost fuel cell 2, and a lower clamping plate 36 lies atop the lowermost fuel cell 2. The fuel cell unit 1 comprises approximately 200 to 400 fuel cells 2, not all of which are shown in FIGS. 4 to 5 for illustrative reasons. The clamping elements 33 impart a compression force on the fuel cells 2. In other words, the upper clamping plate 35 imparts a compression force on the uppermost fuel cell 2, and the lower clamping plate 36 imparts a compression force on the lowermost fuel cell 2. The fuel cell stack 40 is thus braced in order to ensure tightness for the fuel, the oxidizer and the coolant, in particular due to the elastic seal 11, and also to keep the electrical contact resistance within the fuel cell stack 40 as low as possible. To tension the fuel cells 2 using the tensioning elements 33, four connecting devices 38 are formed on the fuel cell unit 1 as bolts 39, which are subjected to tensile stress. The four bolts 39 are firmly connected to the clamping plates 34.

The fuel cell stack 40 is arranged in a housing 42 (FIG. 5). The housing 42 has an inner side 43 and an outer side 44. A space 41 is formed between the fuel cell stack 40 and the housing 42. The housing 42 is also formed by a connecting plate 47 made of metal, in particular steel. The remaining housing 42 without the connecting plate 47 is fastened to the connecting plate 47 using fixing elements 48 as screws 49. An opening 45 is formed in the connecting plate 47 and in the lower clamping plate 36 for introducing fuel into the channels 12 for fuel. In addition, an opening 46 is formed in the connecting plate 47 and in the lower clamping plate 36 for discharging fuel from the channels 12 for fuel. In the connecting plate 47 and the lower clamping plate 36 as the clamping element 33, further openings (not shown) are formed for the introduction of oxidizer, for the discharge of oxidizer, for the introduction of coolant, and for the discharge of coolant. Therefore, a total of 6 openings are formed in the connecting plate 47 and the lower clamping plate 36 (not shown).

FIG. 6 shows the bipolar plate 10 of the fuel cell 2 in a highly simplified and schematized form. The bipolar plate 10 comprises the channels 12, 13 and 14 as three separate channel structures 29. The channels 12, 13 and 14 are not shown separately in FIG. 6, but merely simplified as a layer of a channel structure 29. The fluid openings 52 on the sealing plates 50 of the bipolar plates 10 and membrane electrode arrangements 6 (not shown) are stacked in a flush manner within the fuel cell unit 1, so that feed and discharge channels 53, 54, 55, 56, 57, 58 are formed. Seals (not shown) are arranged between the sealing plates 50 of the bipolar plate 10 for fluid-tight sealing of the supply and discharge channels 53, 54, 55, 56, 57, 58 formed by the fluid openings 52. The channels 14 are actually formed between a first plate 59 and a second plate 60 of the bipolar plate 10.

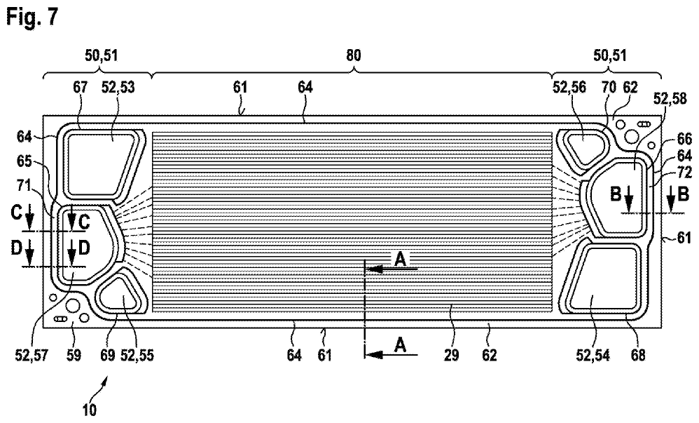

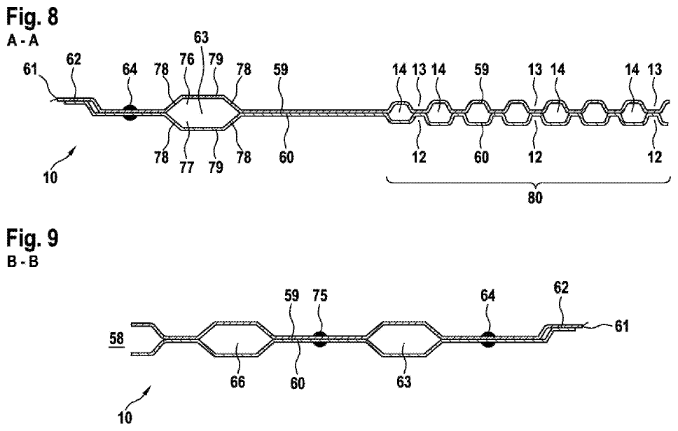

FIG. 7 shows a top view of the bipolar plate 10, including structural details. The feed and discharge channels 53, 54, 55, 56, 57, 58 of the stacked bipolar plates 10 in the fuel cell unit 1 are formed by the individual fluid openings 52 arranged in a flush manner, one above the other. A fluid opening 53 for supplying oxidizer, a fluid opening 54 for discharging oxidizer, a fluid opening 55 for supplying fuel, a fluid opening 56 for discharging fuel, a fluid opening 57 for supplying coolant, and a flood opening 58 for discharging coolant are formed in the bipolar plate 10. The metal bipolar plate 10 is formed by 2 plates 59, 60 stacked in a flush manner, i.e., a first plate 59 and a second plate 60. The bipolar plate 10, and thus also the first plate 59 and the second plate 60, comprises an outer edge 61 as an outer end 61 of the bipolar plate 10 in a direction parallel to the imaginary plane 37 spanned by the essentially planar bipolar plate 10. The bipolar plate 10 and the first plate 59, as well as the second plate 60, comprise an outer edge region 62 starting with the outer edge 61. The outer edge 61 has a width of less than 25% or 30% of the width of the bipolar plate 10 on the wide side. An outer circumferential bead 63 is formed in the bipolar plate 10, i.e. between the first plate 59 and the second plate 60. The outer circumferential bead 63 is formed completely circumferentially without interruption in the outer edge region 62 of the bipolar plate 10. FIG. 8 shows an example of the design of a bead, i.e. in this case the outer circumferential bead 63. A partial bead 76 is formed in the first plate 59 and a partial bead 77 is formed in the second plate 60. The partial beads 76, 77 are formed or delimited by 2 flank walls 78 and a connecting wall 79, which connects the two flank walls 78 together. The connecting wall 79 is oriented essentially parallel to the imaginary plane 37, i.e. with a deviation of less than 30°, 20°, 10°, or 5°. The two partial beads 76, 77 are flush and thus form the larger outer circumferential bead 63. Deviating from this, the bead 63 can also be designed such that only a partial bead 76, 77 is formed on only one plate 59, 60. The outer circumferential bead 63 is thus a channel formed and delimited by the first plate 59 and the second plate 60 due to the geometry of the first plate 59 and the second plate 60. An outer circumferential weld seam 64 (FIGS. 8 to 12; not shown in FIG. 7) is formed completely around the outer edge region 62 between the outer circumferential bead 63 and the outer edge 61. The coolant is arranged between the two plates 59, 60 or the coolant flows between the two plates 59, 60, so that the outer circumferential weld seam 64 serves not only to join or connect the two plates 59, 60 to each other, but also to seal the space between the first plate 59 and the second plate 60 filled with the coolant to the outside. Due to the completely around the outer weld seam 64, no coolant flows from the space between the first and second plate 59, 60 to the outside at the outer edge 61 of the bipolar plate 10.

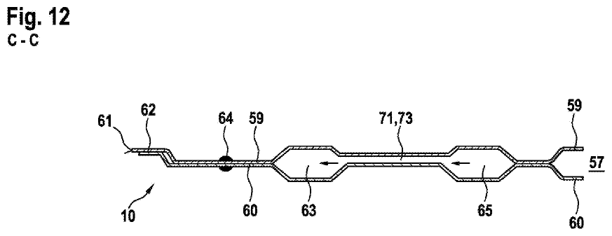

The fluid opening 57 for supplying coolant is completely enclosed by a coolant supply bead 65. The fluid opening 58 for discharging coolant is completely enclosed by a coolant discharge bead 66. The fluid opening 53 for the supply of oxidizer is completely enclosed by an oxidizer supply bead 67. The fluid opening 54 for discharging oxidizer is completely enclosed by an oxidizer discharge bead 68. The fluid opening 55 for supplying fuel is completely enclosed by a fuel supply bead 69. The fluid opening 56 for discharging fuel is completely enclosed by a fuel discharge bead 70. A coolant supply weld seam 74 is formed between the outer circumferential bead 63 and the coolant supply bead 65 (FIG. 11). A coolant discharge weld seam 75 is formed between the outer circumferential bead 63 and the coolant discharge bead 66 (FIG. 9).

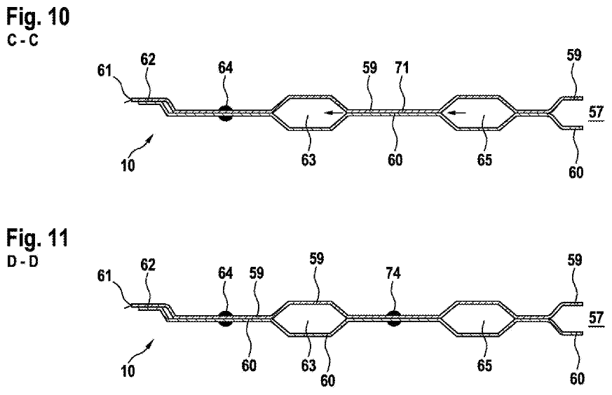

The membrane electrode arrangements 6 and the gas diffusion layers 9 are arranged between the stacked bipolar plates 10 in the fuel cell unit 1. The active region 80 of the bipolar plates 10 is the region comprising the channels 12, 13, 14 for fuel, oxidizer, and coolant, and this active region 80 of the bipolar plates 10 is flush with the fuel cell unit 10 comprising the proton exchange membrane 5, as well as the anodes 7 and cathodes 8. After the fuel cell unit 1 has been manufactured, the fuel cell unit 1 is conditioned. For this purpose, a conditioning fluid is conducted through the channels 12, 13 and 14, and thus also through the fluid openings 52. This conditioning fluid also flows into the outer circumferential bead 63, so that after conditioning the outer circumferential bead 63 is filled with the conditioning fluid without antifreeze. In the bipolar plate 10, an interruption of the coolant supply weld seam 74 is formed in a partial region as shown in FIG. 10 as the section C-C, so that a first fluid-conducting connection 71 is formed from the coolant supply bead 65 into the outer circumferential bead 63 as shown in FIG. 10. In a similar way, an interruption of the coolant supply weld seam 74 is formed in the bipolar plate 10 in a partial region as shown in FIG. 7, so that a second fluid-conducting connection 72 is formed from the coolant discharge bead 66 into the outer circumferential bead 63 as shown in FIG. 7.

When the coolant is conducted through the fuel cell unit 1, the coolant has a greater pressure at the supply channel 57 for coolant and at the fluid openings 57 for supplying coolant than at the discharge channel 58 for coolant and the fluid openings 58 for discharging coolant. This also applies in a similar manner to the conduction of other fluids through the channels 14 for coolant, as well as the supply channel 57 and the discharge channel 58. After the fuel cell unit 1 has been conditioned, a flushing fluid is conducted through the supply channel 57 or the fluid openings 57, the channels 14 for coolant and the discharge channel 58, or the fluid openings 58 for coolant. Due to the pressure of this flushing fluid in the supply channel 57 and the discharge channel 58, i.e. the greater pressure of the flushing fluid in the supply channel 57 than in the discharge channel 58, the flushing fluid flows from the fluid openings 57 through the space between the first and second plates 59, 60 into the coolant supply bead 65 and due to the interruption of the weld seam 74 and the associated formation of the first fluid-conducting connection 71, a small volumetric flow of the flushing fluid can flow into the outer circumferential bead 63. This volumetric flow of the flushing fluid, which flows through the first fluid-conducting connection 71 into the outer circumferential bead 63, takes the conditioning fluid with it, i.e. blows the conditioning fluid out, for example in the case of flushing fluid as a flushing gas. This volumetric flow of the flushing fluid then flows along with the conditioning fluid through the two outer circumferential beads 63 on the longitudinal sides of the bipolar plate 10 to the second fluid-conducting connection 72. This volumetric flow of the flushing fluid along with the conditioning fluid then flows through the second fluid-conducting connection 72 from the outer circumferential bead 63 into the coolant discharge bead 66 and from the coolant discharge bead 66 through the space between the first and second plates 59, 60 into the discharge channel 58 for coolant.

In a second exemplary embodiment of the bipolar plate 10, the first fluid-conducting connection 71 is formed as a connecting bead 73 or as a connecting channel 73 as shown in FIG. 12 from the coolant supply bead 65 into the outer circumferential bead 63. Therefore, the first fluid-conducting connection 71 is not designed as a short interruption of the coolant supply weld seam 74, as in the first exemplary embodiment of the bipolar plate 10, but, due to the geometry of the first plate 59 and the second plate 60, the connecting channel 73 is designed to have a very small cross-sectional area.

In a further exemplary embodiment, the flushing of the conditioning fluid from the outer circumferential bead 63 is performed by conducting a flushing fluid at a high pressure, for example greater than 5 bar, 10 bar or 20 bar, through the channels 12, 13, 14 and the fluid openings 52 in the channels 12, 13, 14 and the fluid openings 52, so that the fuel cell stack 40 of the fuel cell unit 1 is enlarged in the expansion perpendicular to the imaginary planes 37 due to expansion and a small gap is thereby formed between the first plate 59 and the second plate 60 of a respective bipolar plate 10 and the conditioning fluid can thereby be flushed out of the outer circumferential bead 63 using the flushing fluid.

Overall, the bipolar plate 10 according to the invention, the method according to the invention for conditioning the fuel cell unit 1, the fuel cell unit 1 according to the invention, and the fuel cell system 4 according to the invention have significant advantages. After the fuel cell unit 1 has been conditioned, the conditioning fluid remains in the outer circumferential bead 63 on the wide sides, i.e. in the regions of the outer circumferential bead 63 between the fluid openings 52 and the outer edge 61, without antifreeze. Due to the formation of the first and second fluid-conducting connections 71, 72 between the fluid openings 52 and the outer edge 61 as the broad sides of the bipolar plate 10, the flushing fluid can be introduced into these regions of the outer circumferential bead 63, so the conditioning fluid can be flushed out or blown out without antifreeze. The length of the wide sides of the bipolar plate 10 corresponds to the width of the bipolar plate 10. The length of the long sides of the bipolar plate 10 corresponds to the length of the bipolar plate 10. The flushing fluid automatically flows through the outer circumferential bead 63 between the outer edge 61 acting as the longitudinal sides and the active region 80 due to the conduction of coolant between the first and second plates 59, 60. The cross-sectional areas of the first fluid-conducting connection 71 and the second fluid-conducting connection 72 are designed such that only a very small volumetric flow of flushing fluid flows through the first and second fluid-conducting connections 71, 72. After the fuel cell unit 1 has been fully completed, i.e. the conditioning fluid has been removed from the outer circumferential bead 63, the coolant flows continuously through the first and second fluid-conducting connections 71, 72 during operation of the fuel cell unit 1. As a result, a bypass for the coolant from the supply channel 57 to the discharge channel 58 through the outer circumferential bead 63 is formed as a continuous controlled flow through the outer circumferential bead 63, but the energy losses due to this bypass for conveying the coolant are low because only a very small volumetric flow of coolant flows through the first and second fluid-conducting connection 71, 72. The additional mechanical drive power required for a coolant pump due to the volumetric flow of the coolant through the first and second fluid-conducting connections 71, 72 is negligible. In an advantageous manner, no freeze damage can thus occur on the fuel cell unit 1, even during operation at temperatures below 0°, because conditioning fluid can be removed completely from the outer circumferential bead 63 after conditioning using the flushing fluid.

1. A bipolar plate (10) for a fuel cell unit (1) comprising:
a first plate (59),
a second plate (60), wherein the first plate (59) and second plate (60) are stacked on top of each other,
a fluid opening (57) for supplying coolant to channels (14) of the bipolar plate (10) for coolant in an active region (80),
a fluid opening (58) for discharging coolant from channels (14) of the bipolar plate (10) for coolant in the active region (80),
channel structures (29) with channels (12, 13, 14) for fuel, oxidizer, and coolant in the active region (80), wherein the channels (14) for coolant are formed in the active region (80) between the first and second plate (59, 60),
an outer bead (63) which is formed on an outer edge region (62) of the bipolar plate (10) and encloses the fluid opening (57) for supplying coolant and the fluid opening (58) for discharging coolant,
a coolant supply bead (65) which encloses the fluid opening (57) for supplying coolant to channels (14) of the bipolar plate (10) for coolant,
a coolant discharge bead (66) which encloses the fluid opening (58) for discharging coolant from channels (14) of the bipolar plate (10) for coolant,
wherein
a first fluid-conducting connection (71) from the coolant supply bead (65) into the outer bead (63) and a second fluid-conducting connection (72) from the outer bead (63) into the coolant discharge bead (66) are configured to remove conditioning fluid from the outer bead (63).

2. The bipolar plate according to claim 1,
wherein
a coolant supply weld seam (74) is formed between the first and second plates (59, 60) and encloses the fluid opening (57) for supplying coolant to channels (14) of the bipolar plate (10) for coolant.

3. The bipolar plate according to claim 1,
wherein
a coolant discharge weld seam (75) is formed between the first and second plates (59, 60) and encloses the fluid opening (58) for discharging coolant from channels (14) of the bipolar plate (10) for coolant.

4. The bipolar plate according to claim 2,
wherein
the coolant supply weld seam (74) encloses the coolant supply bead (65), so that a distance of the coolant supply weld seam (74) in a direction parallel to an imaginary plane (37) spanned by the bipolar plate (10) to the fluid opening (57) for supplying coolant to channels (14) of the bipolar plate (10) for coolant is greater than a distance of the coolant supply bead (65) in the direction to the fluid opening (57) for supplying coolant to channels (14) of the bipolar plate (10) for coolant.

5. The bipolar plate according to claim 3
wherein
the coolant discharge weld seam (75) encloses the coolant discharge bead (66), so that a distance of the coolant discharge weld seam (75) in a direction parallel to an imaginary plane (37) spanned by the bipolar plate (10) to the fluid opening (58) for discharging coolant from channels (14) of the bipolar plate (10) for coolant is greater than a distance of the coolant discharge bead (66) in the direction to the fluid opening (58) for discharging coolant from channels (14) of the bipolar plate (10) for coolant.

6. The bipolar plate according to claim 2,
wherein
the first fluid-conducting connection (71) from the coolant supply bead (65) into the outer bead (63) is configured as an interruption of the coolant supply weld seam (74).

7. The bipolar plate according to claim 3,
wherein
the second fluid-conducting connection (72) from the coolant discharge bead (66) into the outer bead (63) is configured as an interruption of the coolant discharge weld seam (75).

8. The bipolar plate according to claim 1,
wherein
the first fluid-conducting connection (71) from the coolant supply bead (65) into the outer bead (63) and/or the second fluid-conducting connection (72) from the outer bead (63) into the coolant discharge bead (66) is/are configured as a connecting bead (73) and/or as a connecting channel (73) between the first and second plate (59, 60).

9. The bipolar plate according to claim 1,
wherein
the outer bead (63), which is formed on the outer edge region (62) of the bipolar plate (10), is formed completely circumferentially on the outer edge region (62).

10. A method for conditioning a fuel cell unit (1) comprising stacked fuel cells (2) before the fuel cell unit (1) is put into operation, and channels (12) for conducting a fuel, channels (13) for conducting an oxidizer, and channels (14) for conducting a coolant are formed in bipolar plates (10) of the fuel cells (2) of the fuel cell unit, said method comprising the following steps:
providing a conditioning fluid,
conducting the conditioning fluid through the channels (12) for fuel and/or conducting the conditioning fluid through the channels (13) for oxidizer and/or conducting the conditioning fluid through the channels (14) for coolant,
wherein
the method is performed using a fuel cell unit (1) comprising fuel cells (2) with bipolar plates (10) according to claim 1
and/or,
after conducting the conditioning fluid through the channels (12) for fuel and/or after conducting the conditioning fluid through the channels (13) for oxidizer and/or after conducting the conditioning fluid through the channels (14) for coolant, the conditioning fluid is essentially completely discharged from outer beads (63) of the bipolar plates (10).

11. The method according to claim 10,
wherein
after the conditioning fluid has been guided through, a flushing fluid is guided through fluid openings (57) for supplying coolant and fluid openings (58) for discharging coolant, so that the conditioning fluid is essentially completely discharged from the flushing fluid in the outer beads (63).

12. The method according to claim 11,
wherein
the flushing fluid is a flushing gas or a flushing fluid.

13. The method according to claim 10,
wherein
after conducting the conditioning fluid through the channels (12) for fuel and/or after conducting the conditioning fluid through the channels (13) for oxidant and/or after conducting the conditioning fluid through channels (14) for coolant, the conditioning fluid is discharged from the outer beads (63) of the bipolar plates (10) by increasing a pressure of fluids in the channels (12, 13, 14) for fuel and/or oxidizer and/or coolant is increased, so that an expansion of the fuel cell stack (40) perpendicular to imaginary planes (37) is increased due to expansions and a gap is formed between each of first and second plates (59, 60) on a respective bipolar plate (10) and a flushing fluid is introduced into the outer beads (63) through the respective gap.

14. A fuel cell unit (1) for the electrochemical generation of electrical energy, comprising:
stacked fuel cells (2) and the fuel cells (2) each comprise stacked layered components (5, 6, 7, 8, 9, 10) and the components (5, 6, 7, 8, 9, 10) of the fuel cells (2) are proton exchange membranes (5), anodes (7), cathodes (8), gas diffusion layers (9) and bipolar plates (10) and the stacked fuel cells (2) form a fuel cell stack (40),
wherein
the bipolar plates (10) are designed according to claim 1.

15. A fuel cell system (4) comprising:
a fuel cell unit (1) as a fuel cell stack (40) comprising fuel cells (2),
at least one compressed gas storage means (21) for storing gaseous fuel,
a gas conveying device (22) for conveying a gaseous oxidizer to cathodes (8) of the fuel cells (2),
wherein
the fuel cell unit (1) is designed according to claim 14.

16. The method according to claim 11, wherein the flushing fluid is conducted through first fluid-conducting connections (71) from the coolant supply beads (65) into the outer beads (63) and through second fluid-conducting connections (72) from the outer beads (63) into the coolant discharge beads (66).

17. The bipolar plate according to claim 2, wherein a coolant discharge weld seam (75) is formed between the first and second plates (59, 60) and encloses the fluid opening (58) for discharging coolant from channels (14) of the bipolar plate (10) for coolant.

18. The bipolar plate according to claim 17, wherein the coolant supply weld seam (74) encloses the coolant supply bead (65), so that a distance of the coolant supply weld seam (74) in a direction parallel to an imaginary plane (37) spanned by the bipolar plate (10) to the fluid opening (57) for supplying coolant to channels (14) of the bipolar plate (10) for coolant is greater than a distance of the coolant supply bead (65) in the direction to the fluid opening (57) for supplying coolant to channels (14) of the bipolar plate (10) for coolant.

19. The bipolar plate according to claim 18, wherein the coolant discharge weld seam (75) encloses the coolant discharge bead (66), so that the distance of the coolant discharge weld seam (75) in the direction parallel to th imaginary plane (37) spanned by the bipolar plate (10) to the fluid opening (58) for discharging coolant from channels (14) of the bipolar plate (10) for coolant is greater than the distance of the coolant discharge bead (66) in the direction to the fluid opening (58) for discharging coolant from channels (14) of the bipolar plate (10) for coolant.
